(19) United States
(12) Patent Application Publication
(10) Pub. No.: US 2020/0097275 A1
(43) Pub. Date: Mar. 26, 2020

(54) AUTOMATED COMPATIBILITY VERIFICATION FOR SOFTWARE PURCHASES PRIOR TO PURCHASE

(71) Applicant: INTERNATIONAL BUSINESS MACHINES CORPORATION, Armonk, NY (US)

(72) Inventors: Jeremy A. Greenberger, San Jose, CA (US); Lisa Seacat DeLuca, Baltimore, MD (US); Jeremy R. Fox, Georgetown, TX (US); Kelley Anders, East New Market, MD (US)

(21) Appl. No.: 16/136,348

(22) Filed: Sep. 20, 2018

(51) Int. Cl. G06F 8/65; G06Q 30/06

(52) U.S. Cl. CPC G06F 8/65; G06Q 30/0621

(57) ABSTRACT

A pre-purchase method for determining computing item compatibility. In the method, the system will establish an operating system or, generally, a computing environment baseline indicative of an existing version of an operating system or computing environment for a computing device and then store a list of computer software to be added to said computing device that was generated based on guidance provided by a user. The system will determine that at least a portion of the computing environment and/or operating system has been updated to an updated version of said operating system then compare characteristics of the list of computer software with the updated version of the operating system or computing environment. Next, the system will determine that a program included in the list of computer software has a conflict with the updated version and notify the user of the conflict.

### FIELD OF THE INVENTION

The present invention relates to the field of commerce and more particularly, to a technique of automated compatibility checking for software purchases prior to purchase.

### DESCRIPTION OF THE RELATED ART

Consumers typically know what software they would like to purchase, but they might not understand all of the software requirements based on operating systems versus the software that the consumer may want to install. Many different hardware and software platforms exist, each having specific compatibility requirements. As the consumer migrates to a new upgrade with the operating system, currently the consumer has to check for system level compatibility for system level requirements.

Many times, consumers purchase items only to discover later that these items do not operate with their existing system. Having purchased an item that is not compatible with their system, the consumer will attempt to return the item to the retailer which requires the consumer to go through the retailer's item return procedures. Some retailers do not permit software/hardware computing components to be returned at all. Other retailers charge a significant restocking fee (e.g., fifteen percent or more). On the retailer side of an incompatible purchase, retailers are forced to sell returned items as open box items which can cost the retailer money. Essentially, hardware/software incompatibilities currently cost both the consumer and the retailer time and money.

This situation results in a negative impact to consumers and to retailers, who often receive unhappy customer complaints about purchased hardware and/or software. Software returns can be particularly problematic due to network activation codes, as a new purchaser may have problems re-activating a previously activated software product. This may in turn create a cycle where all parties involved have lost resources through these activities, even though all involved parties have acted in good faith.

Today, consumers have a wishlist or cart of software that they may want to purchase and apply to their system. The consumer may have previously addressed these software title to a personal list which they have stored locally or on a cloud based system. Or, the consumer also has a running shopping cart of things that they are planning on purchasing. As the user's operating system evolves, the conventional purchase techniques do not organically evolve with operating system changes or provide an alert of potential compatibility problems.

### SUMMARY OF THE INVENTION

The present invention discloses a system and a method for determining computing item compatibility. In the method, the system will establish a computing environment baseline indicative of an existing version of software functioning on a computing device and then store a list of computer software to be added to said computing device that was generated based on guidance provided by a user. The system will determine that at least a portion of the computing environment has been updated to an updated version of the computing environment then compare characteristics of the list of computer software with the updated version. Next, the system will determine that a program included in the list of computer software has a conflict with the updated version in the computing environment and notify the user of the conflict.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via a carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of an automated compatibility checking system for determining a compatibility of hardware/software items with a target computing system before a purchase of the items is completed in accordance with an embodiment of the inventive arrangements disclosed herein.

FIG. 2A illustrates a flowchart showing the operational steps for a item compatibility engine 130 for analyzing the compatibility of products contemplated for purchase with a user's existing wishlist in accordance with an embodiment of the present invention.

FIG. 2B illustrates a flowchart showing the operational steps for a item compatibility engine 130 for analyzing the product compatibility and providing a user with recommendations after analyzing the compatibility of products in a user's existing wishlist in accordance with an embodiment of the present invention.

FIG. 3 is a flow chart diagram of a method for the automated compatibility checking system for determining the compatibility of hardware/software purchases prior to purchase in accordance with an embodiment of inventive arrangements.

FIG. 4A illustrates one example of the user notification envisioned by the present invention, whereby the notification 400 alerts the user to a potential software conflict; i.e., a Windows® version of turbotax® is in the cart but the user is operating a Mac machine.

FIG. 4B illustrates an example of notification for business or family license arrangements in accordance with this invention.

FIG. 5 depicts a block diagram of components of a computing device, in accordance with an illustrative embodiment of the present invention.

FIG. 6 depicts a cloud computing environment, according to an embodiment of the present invention; and

FIG. 7 depicts abstraction model layers, according to an embodiment of the present invention.

### DETAILED DESCRIPTION OF THE INVENTION

One objective of the present invention is to dynamically analyze and compare a user's wishlist with the latest version(s) of the software to be updated and to accurately reflect that change in the list (ex. wishlist, registry, or shopping cart). The invention will alert the user of the change and presenting a visual in which they can provide feedback to keep or reject the change. If the change is rejected, the original items is updated as stated in the wishlist, If the change is approved, the newer version is applied. Other objectives and features of the present invention will be described below with reference to the appended drawings.

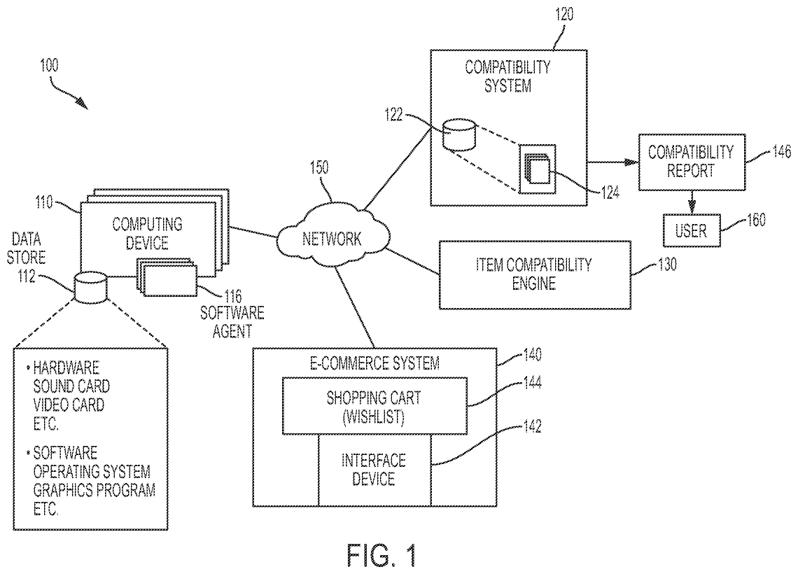

FIG. 1 is a schematic diagram of an automated compatibility checking system 100 for determining a compatibility of hardware/software items with a target computing system before a purchase of the items is completed in accordance with an embodiment of the inventive arrangements disclosed herein. The description provided below will focus on the compatibility of software with an existing operating system; however, it will be understood by those of skill in the art that the benefits of the present invention are equally applicable to compatibility of software with a “computing environment” in general without limiting the invention to any specific operating system.

More specifically, system 100 shows that, while a user is operating a computing device and before a purchase is finalized a for-sale computing item (e.g., software, peripheral, expansion card, memory, and other device). The system will monitor whether the purchase is compatible with a target system.

Turning to system 100 details, a computing device 110, a compatibility system 120, an item compatibility engine 130, and an e-commerce system 140 can each be communicatively linked to a network 150. The computing device 110 can be a target computing device for which a for-sale computing item purchased through the e-commerce system 140 is to be used. A data store 112 of the computing device 110 can specify hardware and software details of the device 110. For example, in a WINDOWS based system, system details are centrally managed by a REGISTRY. Other platforms (e.g., a LINUX based platform or a MACINTOSH based one) have similar hardware/software management components, each of which store system specifics in a memory, as illustrated by data store 112. In one contemplated arrangement, a software agent 116 can also execute upon the computing device 110 to automatically determine hardware/software of the device 110.

Regardless of how specifics for a computing device 110 are determined, these specifics can be conveyed to the compatibility system 120, which creates a subscriber configuration file 124 for the device 110. The compatibility system 120 can store and manage configuration information for multiple different devices 110 for a single subscriber or for multiple different subscribers. For example, a configuration file 124 stored in data store 122 can be related to a subscriber's home computer system (device 110). In another example, compatibility system 120 can maintain configuration files 124 for a set of computing devices 110 used by a business entity and/or managed by a specific administrator.

At a time of purchase, the compatibility system 120 can interface with the e-commerce system 140. For example, when a shopper or user 160, who can be the owner or administrator of computing device 110, adds for-sale computing items to a shopping cart 144, a compatibility report 146 for these for-sale computing items can be presented to the user 160. The compatibility report 146 can indicate whether each item to be purchased is compatible with a computing device 110 associated with or specified by the user 160.

For instance, a target system for the items to be purchased can be input into interface device 142. The e-commerce system 140 can convey an indicator of the target system and details of each of the for-sale items to the compatibility system 120, which references an appropriate configuration file 124 associated with the target system. An item compatibility engine 130 can determine if each item is compatible with the target system based upon details specified within the configuration file 124. For example, the engine 130 can determine if suitable hardware interfaces exist for attaching the item, can determine if minimum system requirements of the item are satisfied, and can query historical data stores to determine if known problems exists that would negatively affect the use of a computing item within the target system. The engine 130 can be a component of system 120 and/or system 140. The engine 130 can also be a processing engine of a remotely located but communicatively linked computing system. In one contemplated embodiment, a compatibility service (e.g., a Web service) can be provided by the compatibility system 120 for the e-commerce system 140 for a fee, which is paid by either the user 160 and/or the e-commerce entity.

As used herein, the computing device 110 can be any computing device for which a configuration file 124 can be generated. The computing device 110 can include a stand-alone computing system, a thin client, a component of a larger computing system, and/or a peripheral device. The peripheral device (e.g., a copier within peripheral specific memory, interface cards, and the like) can have upgradeable hardware/firmware/software components. The computing device 110 can include, but is not limited to a computer, a server, a personal data assistant (PDA), a mobile phone, a wearable computer, an embedded computing system, a media player, a network-enabled consumer electronic device, an entertainment system, a network attached storage (NAS) device, and the like.

A for-sale item can be any item made to interoperate or to be installed within the computing device 110. The for-sale item can include hardware and software. When the for-sale item is associated with a desktop computer (device 110), the for-sale item can include, but is not limited to, RAM, an expansion card, a hard drive, a media drive, a CPU, a peripheral (USB, SATA, PATA, FIREWIRE, and the like), a software application, a software extension or upgrade to a pre-existing application, and the like. A for-sale item can have platform compatibility concerns, hardware interface concerns, software driver concerns, minimum hardware/software requirements, network interface compatibility issues, and the like. The compatibility system 120 can handle each of these compatibility concerns or a configurable subset of the compatibility concerns. Further, in one embodiment, the compatibility system 120 can consider other for-sale items in the shopping cart 144 when generating the compatibility report 146. For example, if a VISTA operating system is included in the shopping cart 144 along with a new video card, the compatibility report 146 can indicate whether a system upgraded with the new video card meets the video requirements for the purchased version of VISTA. The report 146 can further specify whether the video card meets video requirements of upgraded variants of the purchased VISTA software.

The e-commerce system 140 can be any system capable of communicating with compatibility system 120 that is able to identify user 160 specified for-sale items to be purchased. The storefront system 140 can include a server of an e-commerce site, a register used by a cashier within a store, a mobile device (e.g., a smart phone or PDA) carried by user 160 within a store, and/or an in-store kiosk. For example, the e-commerce system 140 can be a check-out system that automatically generates a compatibility report 146 as part of a check-out process. In another example, the user may need to specify a contemplated for-sale item to an interface device 142 not directly linked to a check-out process before the check-out process begins (i.e., by scanning a bar code for the item into a kiosk or entering the item into a network enabled mobile device). The interface device 142 can generate report 146 after exchanging data with the compatibility system 120 and receiving a response from this system 120.

Network 150 can be used to communicatively link different components of system 100 to one another. Network 150 can include any hardware/software/and firmware necessary to convey data encoded within carrier waves. Network 150 can include one or more personal area network (PAN), local area network (LAN), metropolitan area network (MAN), wide area network (WAN), virtual private network (VPN), and the like. Network 150 can also include local components and data pathways necessary for communications to be exchanged among computing device components and between integrated device components and peripheral devices. The network 150 can include line based and/or wireless communication pathways.

Data stores 112 and 122 can be physically implemented within any type of hardware including, but not limited to, a magnetic disk, an optical disk, a semiconductor memory, a digitally encoded plastic memory, a holographic memory, or any other recording medium. Each of the data stores 112 and 122 can be stand-alone storage units as well as a storage unit formed from a plurality of physical devices, which may be remotely located from one another. Additionally, information can be stored within each data store 112 and 122 in a variety of manners. For example, information can be stored within a database structure or can be stored within one or more files of a file storage system, where each file may or may not be indexed for information searching purposes.

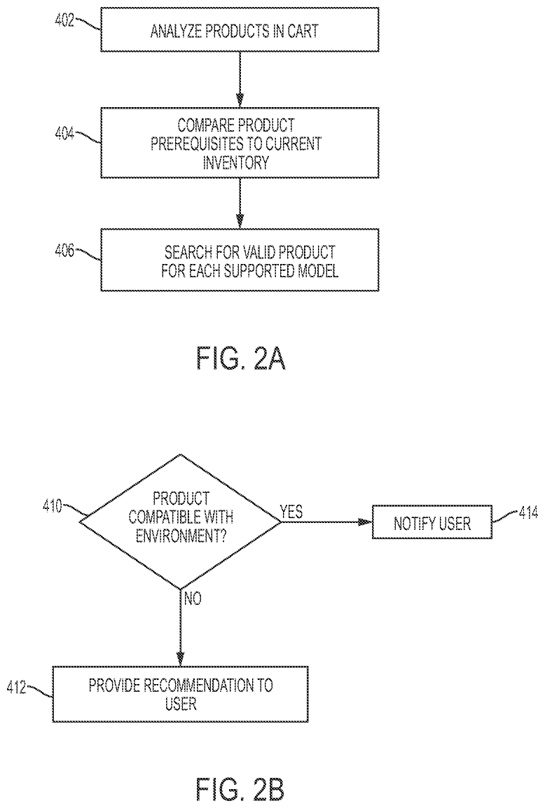

FIG. 2A depicts a flowchart illustrating the operational steps of an item compatibility engine 130 for analyzing the compatibility of products contemplated for purchase with a user's existing inventory of products, in accordance with an embodiment of the present invention. During the purchase, or consideration for purchase, the item compatibility engine 130 can be directly invoked by the user, or can be invoked automatically.

In step 402, the item compatibility engine 130 analyzes products in a cart of the user. In this exemplary embodiment, the item compatibility engine 130 analyzes each product or item in the cart of a user for product specification, which includes prerequisite models, supported models, description characteristics, and any other characteristics which help to identify the product. The cart of the user is typically an electronic shopping cart used in online shopping but may take many forms. As a user gathers one or more products for purchase, the item compatibility engine 130 can analyze a selected product using a browser plugin for online purchases.

In step 404, the item compatibility engine 130 compares the product prerequisites to the current inventory of a user. In this exemplary embodiment, the item compatibility engine 130 can provide context-specific information based on the cart contents of the user, by assessing the product, looking at the product specifications to determine compatible products, and notifying the user if the product does not match any items in the inventory.

In step 406, the item compatibility engine 130 searches for a valid product for each supported model, version and/or solution. For each supported product model, the item compatibility engine 130 examines the current inventory for a valid supported product, and checks the shopping cart for a valid supported product. In the case that no supported product is located, the item compatibility engine 130, by noting the type of product, can provide one or more alternative versions and/or solutions which may be more suitable.

In another embodiment, when the product contemplated for purchase or rental is a media product (e.g., music, video, e-book), the item compatibility engine 130 examines the purchase to determine if the product is a duplicate product, and provide the user with a real-time warning of the prior acquisition. If the item compatibility engine 130 determines that the media product is a duplicate product (i.e., previously purchased or rented), then the item compatibility engine 130 notifies the user of the prior transaction in which the duplicate product was acquired. For example, a user may search through an online storefront of software updates and find a software package would like to buy, forgetting that the user had previously viewed this product. The item compatibility engine 130 can determine that the user has already viewed the same product two months ago, and the user may then remember that they have already seen the contemplated software.

FIG. 2B depicts a flowchart illustrating the operational steps of a item compatibility engine 130 for determining product compatibility and providing a user with recommendations after analyzing the compatibility of a product contemplated for purchase, in accordance with an embodiment of the present invention.

In step 410, the item compatibility engine 130 determines whether a product is compatible with a user's existing environment (e.g., a home or an office). In this exemplary embodiment, after all the prerequisites have been determined, the item compatibility engine 130 evaluates whether the product contemplated for purchase is compatible with the user's existing environment. If the product is compatible, then, in step 414, the item compatibility engine 130 notifies the user, for example, via an alert, smart phone application or a notice disposed in the cart or wishlist.

If, in step 410, the item compatibility engine 130 determines that the product is not compatible with the current user's environment, then in step 412, the item compatibility engine 130 provides recommendations to the user. In one embodiment, if the system determines that the product may overburden the existing environment (i.e., high use of resources), then a warning may be issued to the user. If the system determines that an alternative product in the same store would provide greater compatibility, then the system may output a recommendation to the user to purchase the alternative product. The user may then decide, based on any notifications from the item compatibility engine 130, whether to follow through on the purchase, replace the product with a different recommended item, or not purchase the product at all.

Accordingly, by performing the operational steps of FIGS. 2A and 2B, the item compatibility engine 130 can provide timely insights during the normal process of consumer shopping by determining, at the time of a contemplated purchase, whether the product is appropriate in the environment of the user. Prior to paying for a product and bringing it to the user's environment (and potentially opening the product in a way that it cannot be returned), the product can be assessed to determine whether any prerequisite products are in the current inventory or cart, whether the supported models for a part are in the inventory or cart, and whether the product appears to be a duplicate (e.g., wrong OS, incompatible device, duplicate products). Using an inventory of what the user currently possesses, the item compatibility engine 130 can advise the user if they should purchase a particular product, what product they should buy, or prerequisites for certain products.

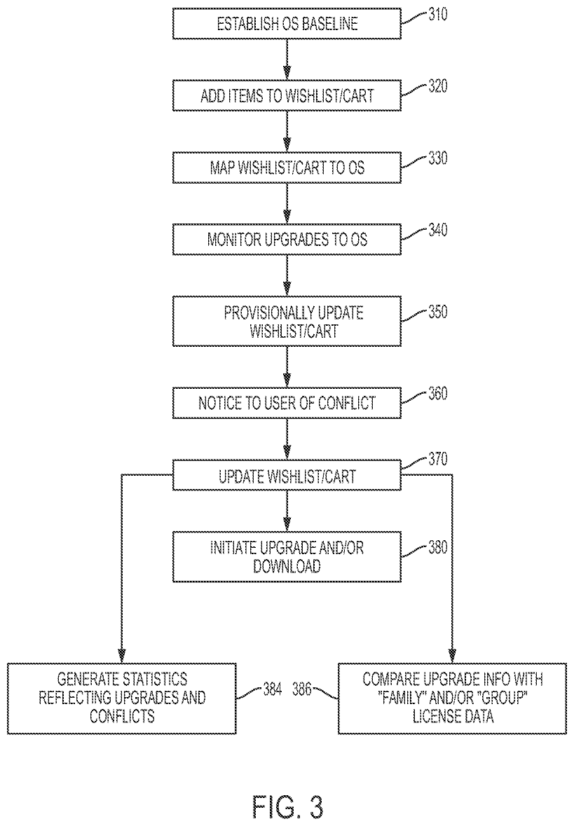

An example of the method of the present invention will now be described and the steps of the invention will then be set forth with reference to FIG. 3. As an example, a user has a local wishlist stored on the user's computer and, in accordance with this invention, the wishlist will be updated as the operating system is updated. In this example, the user has “Snow Leopard” on the user's machine OS and on the user's wishlist, the user has added Adobe Photoshop 5.

When the machine OS updates from “Snow Leopard” to “Yosemite,” the wishlist is automatically updated to compatible versions of Adobe Photoshop based on the changes at the operating system level, and presented to the user for them to approve or reject. The approval or rejection process is visually presented to the user during this process.

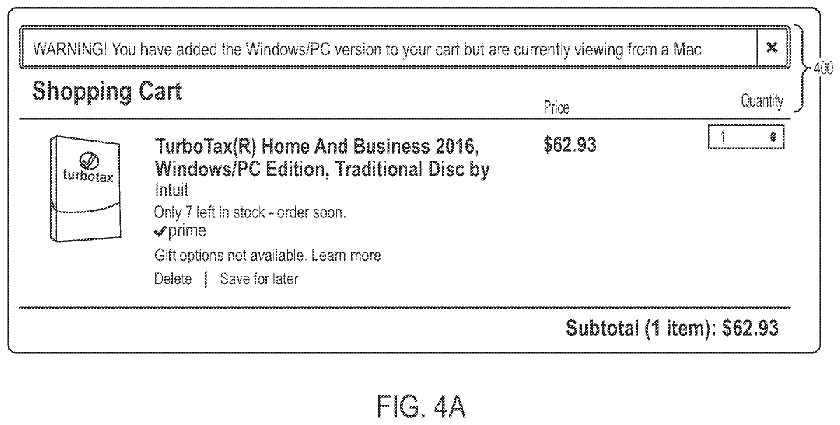

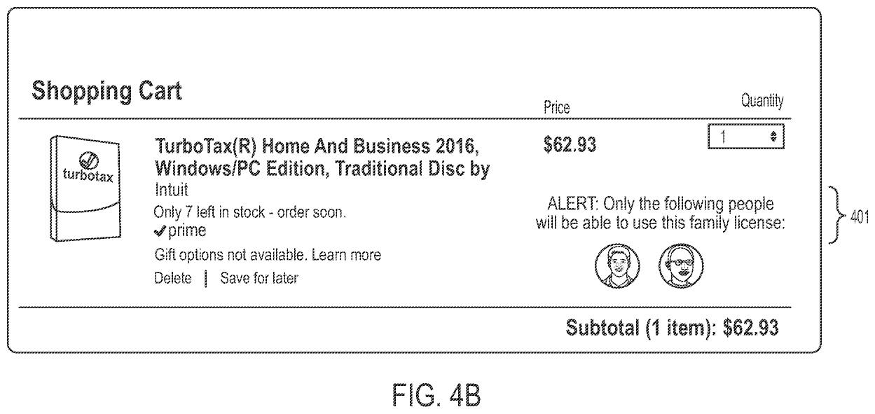

With reference to FIG. 3, the system will first establish the scope of the operating system (OS) baseline at step 310. To accomplish step 310, the system will need to understand/retrieve the current system baseline at the operating system level. The system will determine the OS level, memory requirements, any OS specific requirements. Next, the system will establish or recognize items to be added to the wishlist or universal cart at step 320. As a user utilizes a system, the user will record a potential wishlist/cart of new software that they want to purchase in a manner that is known in the art. In short, the system will document the wishlist/cart within a universal cart on the system at step 320. At step 330, the system will map or determine the coordination of the universal cart to the current operating system (OS). Step 330 ensures that the current items placed in the universal cart are properly mapped to the OS level. Step 330 may be accomplished with existing compatibility applications or reports such as those available in Softlayer® or other relevant applications known to those of skill in the art. At step 340, the system will recognize when the user has defined or executed a potential upgrade to the operating system. The system will recognize any existing and/or potential upgrades to the OS level at step 340. And, at step 350, the system will automatically, but provisionally, update the cart selections for the user's review and the system will also update the related step 330 mapping based on the new OS level identified at step 340. Step 360 involves user notification and step 370 involves an acceptance/rejection process. At step 360, the system can passively update users with minor onscreen notifications that a cart item has been automatically updated to reflect the newest version (or) lack thereof if there is a potential conflict of the wishlist item not being able to be installed on upgraded OS system. If the user accepts the updated wishlist, then they could either manually initiate the update or added automatically to the current update settings at step 380. FIG. 4A illustrates one example of the user notification envisioned by the present invention, whereby the notification 400 alerts the user to a potential software conflict; i.e., a Windows version of turbotax is in the cart but the user is operating a Mac machine.

In an alternate embodiment of the present invention, it is noted that the present invention provides unique benefits to families and businesses where related accounts are utilized by multiple people. Thus, the system may provide business owners with insight on product coordination events. Specifically, this system can enable business owner to get real-time statistics on how many of their loyal customers need an upgrade. The invention may optionally provide business owners with analytics on how many go to purchase products that may or may not fit their machine. For example, this data can then be used to help identify new marketing patterns or even marketing segments of customers (see step 384 in FIG. 3). Additionally, if the product has a “family license,” the invention can display to the user who in his/her family (connected to a social account) can use this product. FIG. 4B illustrates an example of notification for business or family license arrangements in accordance with this invention. As shown in FIG. 4b, a notification 401 may be provided to a user (and/or to a business owner) to alert that members of a group may or may not be compatible with a particular software upgrade etc. (see step 386 in FIG. 3). By showing this alert, the retailer may even be able to reduce returns, even optionally requiring the user to sign off that the user understands that these product will not be compatible with another family member's machine.

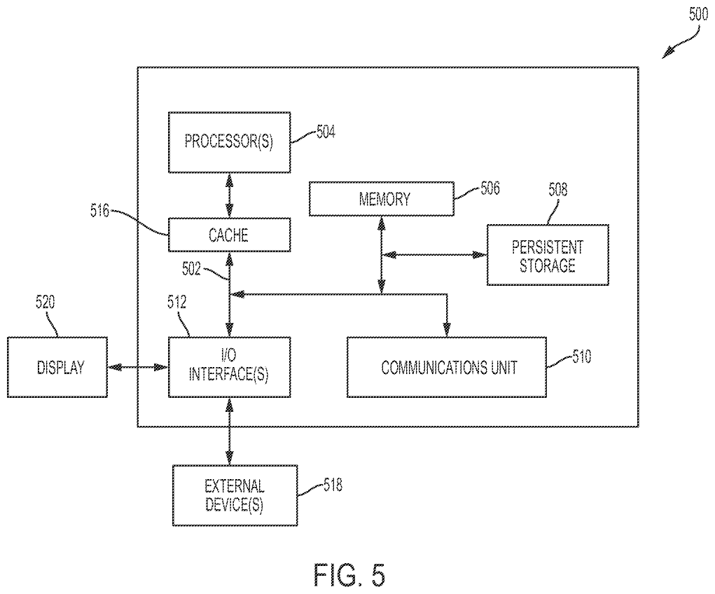

FIG. 5 depicts a block diagram of internal and external components of a computing device, generally designated 500, which is representative of components of FIG. 1, in accordance with an embodiment of the present invention. It should be appreciated that FIG. 5 provides only an illustration of one implementation and does not imply any limitations with regard to the environments in which different embodiments may be implemented. Many modifications to the depicted environment may be made.

Computing device 500 includes communications fabric 502, which provides communications between computer processor(s) 504, memory 506, cache 516, persistent storage 508, communications unit 510, and input/output (I/O) interface(s) 512.

Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM). In general, memory 506 can include any suitable volatile or non-volatile computer readable storage media. Cache 516 is a fast memory that enhances the performance of processors 504 by holding recently accessed data, and data near recently accessed data, from memory 506.

Program instructions and data used to practice embodiments of the present invention may be stored in persistent storage 508 and in memory 506 for execution by one or more of the respective processors 504 via cache 516. In an embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices, including resources of a network. In these examples, communications unit 510 includes one or more network interface cards. Communications unit 510 may provide communications through the use of either or both physical and wireless communications links. Program instructions and data used to practice embodiments of the present invention may be downloaded to persistent storage 508 through communications unit 510.

I/O interface(s) 512 allows for input and output of data with other devices that may be connected to computing device 500. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention (e.g., software and data) can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor, or a television screen.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

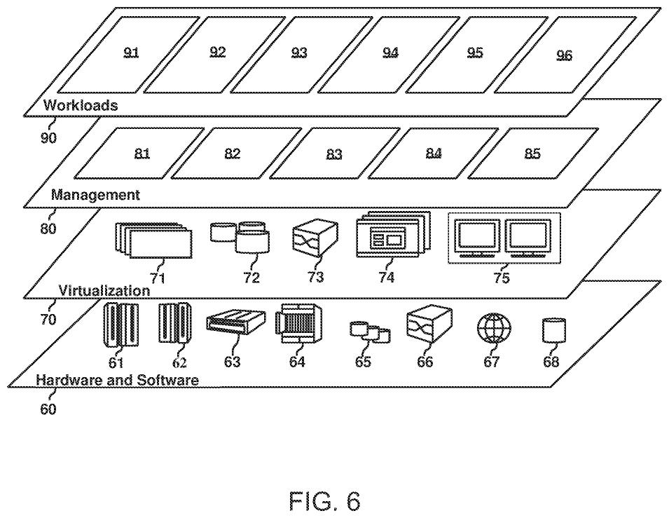

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

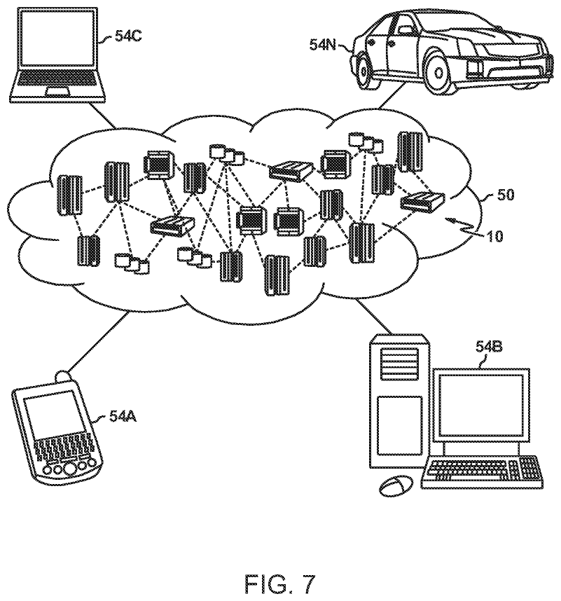

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and wishlist/cart data processing 96.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A method of updating software, the method comprising:
establishing a computing environment baseline indicative of an existing version of software functioning on a computing device;
storing a list of computer software to be added to said computing device that was generated based on guidance provided by a user;
determining that at least a portion of the computing environment has been updated to an updated version;
comparing characteristics of said list of computer software with said updated version;
determining that a program included in the list of computer software has a conflict with said updated version;
notifying the user of said conflict.

2. The method of claim 1, further comprising:
determining that said updated version is an updated operating system; and
determining that a program included in the list of computer software has an upgraded version that is compatible with the updated version of the operating system.

3. The method of claim 2, further comprising:
based on an update setting, automatically updating the program to the upgraded version that is compatible with the updated version of the operating system.

4. The method of claim 2, further comprising:
based on a user instruction, updating the program to the upgraded version that is compatible with the updated version of the operating system.

5. The method of claim 1, further comprising:
receiving from a user an indication that a given program is to be upgraded based on a current version of the computing environment.

6. The method of claim 1, further comprising:
responsive to detection of the update to the computing environment, presenting the user with a notification that (i) identifies the upgraded version that is compatible with the updated version of the computing environment and (ii) requests permission to upgrade the program to be the upgraded version.

7. The method of claim 1, further comprising:
generating statistics reflecting a number and type of said conflict and said updated version of said computing environment.

8. The method of claim 1, further comprising:
comparing information related to said upgraded version with other members of a group license related to at least one of said updated version of said computing environment and said upgraded version of said software to enable members of said group license to have notice of potential conflicts with regard to said computing environment.

9. The method of claim 1, further comprising:
provisionally updating said list of software programs with said upgraded version when said conflict is determined, said provisionally updating occurring prior to notifying the user of said conflict.

10. A computer program product comprising:
a computer-readable storage device; and
a computer-readable program code stored in the computer-readable storage device, the computer readable program code containing instructions executable by a processor of a computer system to implement a method for updating software, the method comprising:
establishing a computing environment baseline indicative of an existing version of software functioning on a computing device;
storing a list of computer software to be added to said computing device that was generated based on guidance provided by a user;
determining that at least a portion of the computing environment has been updated to an updated version;
comparing characteristics of said list of computer software with said updated version;
determining that a program included in the list of computer software has a conflict with said updated version;
notifying the user of said conflict.

11. The computer program product of claim 10, further comprising the steps of:
determining that said updated version is an updated operating system; and
determining that a program included in the list of computer software has an upgraded version that is compatible with the updated version of the operating system.

12. The computer program product of claim 11, further comprising the step of:
based on an update setting, automatically updating the program to the upgraded version that is compatible with the updated version of the operating system.

13. The computer program product of claim 11, further comprising the step of:
based on a user instruction, updating the program to the upgraded version that is compatible with the updated version of the operating system.

14. The computer program product of claim 10, further comprising the step of:
receiving from a user an indication that a given program is to be upgraded based on a current version of the computing environment.

15. The computer program product of claim 10, further comprising:
responsive to detection of the update to the computing environment, presenting the user with a notification that (i) identifies the upgraded version that is compatible with the updated version of the computing environment and (ii) requests permission to upgrade the program to be the upgraded version.

16. The computer program product of claim 10, further comprising:
generating statistics reflecting a number and type of said conflict and said updated version of said computing environment.

17. The computer program product of claim 10, further comprising:
comparing information related to said upgraded version with other members of a group license related to at least one of said updated version of said computing environment and said upgraded version of said software to enable members of said group license to have notice of potential conflicts with regard to said computing environment.

18. A computer system, comprising:
a processor;
a memory coupled to said processor; and
a computer readable storage device coupled to the processor, the storage device containing instructions executable by the processor via the memory to implement a method for updating software, the method comprising the steps of:
establishing a computing environment baseline indicative of an existing version of software functioning on a computing device;
storing a list of computer software to be added to said computing device that was generated based on guidance provided by a user;
determining that at least a portion of the computing environment has been updated to an updated version;
comparing characteristics of said list of computer software with said updated version;
determining that a program included in the list of computer software has a conflict with said updated version;
notifying the user of said conflict.

19. The computer system of claim 18, further comprising the steps of:
determining that said updated version is an updated operating system; and
determining that a program included in the list of computer software has an upgraded version that is compatible with the updated version of the operating system.

20. The computer system of claim 19, further comprising the step of:
based on an update setting, automatically updating the program to the upgraded version that is compatible with the updated version of the operating system.
